(19) United States
(12) Patent Application Publication
(10) Pub. No.: US 2008/0025602 A1
(43) Pub. Date: Jan. 31, 2008

(54) Apparatus and method for performing color conversion using color cache in image processing system

(75) Inventors: Seok-Jin Won, Seongnam-si (KR); Sang-Wook Oh, Ansan-si (KR); Yun-Je Oh, Yongin-si (KR); Sung-Dae Cho, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/880,906

(22) Filed: Jul. 25, 2007

(30) Foreign Application Priority Data
Jul. 25, 2006 (KR) 2006-69830

(51) Int. Cl. G06K 9/00

(52) U.S. Cl. 382/167

(57) ABSTRACT

An apparatus and method for performing color conversion using a color cache is disclosed. The apparatus includes a color converter for acquiring an after conversion color by performing a color conversion operation of a color of a predetermined pixel, a color cache for storing before conversion colors and after conversion colors of previous pixels color-converted by the color converter and searching for the same color by comparing the color of the predetermined pixel to the stored colors before conversion when the predetermined pixel is input, and a controller for transmitting the color of the predetermined pixel to the color cache, controlling the color cache to search whether the same color as that of the predetermined pixel is stored in the color cache, acquiring a after conversion color from the color converter or the color cache according to the search result, and transmitting the color after conversion to the outside.

### CLAIM OF PRIORITY

This application claims the benefit of the earlier filing date, under 35 U.S.C. §119(a), to that patent application filed in the Korean Intellectual Property Office on Jul. 25, 2006 and assigned Serial No. 2006-69830, the contents of which are incorporated herein by reference.

### BACKGROUND OF THE INVENTION

1. Field of the Invention

The present invention relates to a color conversion apparatus of an image processing system, and in particular, to an apparatus and method for performing color conversion using a color cache in an image processing system.

2. Description of the Related Art

Accompanying the development of digital technology and the increase of multimedia services, various media supporting a digital multimedia service have been developed. In addition, it is expected that the commercialization of a digital broadcast service results in an increase of digital image device industry.

Recently, display devices, such as scanners, printers, monitors, and mobile Liquid Crystal Displays (LCDs), for reproducing colors tend to have a variety of functions, high quality, and a low price and use different color spaces and color models according to application fields in order to satisfy various requirements of users.

For example, a Red-Green-Blue (RGB) color space is used in a field using a computer monitor, and a Cyan-Magenta-Yellow-Black (CMYK) color space is used in a printing field. In addition, a Commission Internationable de I'Eclairage (CIE) color space may be used in order to correctly reproduce colors in any device, i.e., to define device independent colors. The CIE color space can be divided into a CIE-XYZ color space, a CIE L*a*b* color space, a CIE LUV color space, and so on. Since the CIE color space can be easy to use in a Personal Computer (PC) and represent a wide range of colors, the CIE color space is widely used.

Although an RGB color model is mainly used to represent colors in a digital image, the RGB color model is device-dependent and difficult to perform correct color calibration, and thus, a color conversion process of converting the RGB color model to a CIE L*a*b* color model is commonly performed.

Existing color conversion methods can be classified into 4 color conversion methods, which will now be schematically described.

The first color conversion method is a method of performing color conversion using algorithm formulas directly implemented by a display device manufacturer or a user.

The second color conversion method is a method of performing color conversion by sampling only some colors in an entire color space, generating a conversion Color Look-Up Table (CLUT) of the sampled colors, and using various interpolation methods, e.g., tetrahedral interpolation, tri-linear interpolation, and the like, for the remaining colors.

The third color conversion method is a method of performing color conversion using a polynomial regression-based interpolation equation.

The fourth color conversion method is a method of performing color conversion using a color mapping table of an entire color space.

The third color conversion method using the polynomial regression-based interpolation equation performs the color conversion using a polynomial regression equation obtained by simplifying an original color conversion formula, and the fourth color conversion method using a color mapping table of an entire color space can be used for a 16-bit color format or smaller color formats requiring a memory size of equal to or less than 2¹⁶×2=128 KB due to the limitation of a table size.

In a case where color conversion is performed to display an image, since a high performance process is required, when any of the first three color conversion methods is performed, the method may be implemented as hardware, and when the fourth color conversion method is performed, the method may be implemented as software.

FIG. 1 is a diagram for describing a method of performing color conversion using a CLUT among existing color conversion methods.

Referring to FIG. 1, the method of performing color conversion using a CLUT, which is a most popularly used color conversion method, will now be described. Some colors in an entire color space are sampled and stored in a CLUT, and the remaining colors, which are not stored in the CLUT, are converted using various interpolation methods, e.g., tetrahedral interpolation, tri-linear interpolation, and the like.

In the CLUT, pairs of color values before and after the color conversion is performed may be stored. In FIG. 1, RGB items are colors before the color conversion is performed, and Lab items are colors after the color conversion is performed. If RGB color values of a pixel input to a color conversion apparatus are respectively 73, 29, and 28, corresponding Lab color values are respectively 30, 29, and 11.

However, since the existing color conversion methods of color conversion apparatuses do not reuse color information used in a previous pixel, a color conversion operation of the same costs must be always performed for every pixel. For image data, however, color values of a previously converted pixel are frequently the same as color values of a current pixel, and if this information is used, unnecessary color conversion can be reduced.

### SUMMARY OF THE INVENTION

Accordingly, an aspect of the present invention is to provide an apparatus and method for performing color conversion using a color cache to reduce unnecessary color conversion operations and memory access, reduce power consumption, and increase color conversion speed by storing previously converted color information and comparing the color information and a color of a currently input pixel using the color cache in an image processing system.

According to one aspect of the present invention, there is provided an apparatus for performing color conversion using a color cache, the apparatus comprising a color converter for acquiring a color after conversion by performing a color conversion operation of a color of a predetermined pixel for color conversion when the predetermined pixel is input, a color cache for storing colors before conversion and colors after conversion of previous pixels color-converted by the color converter and searching for the same color by comparing the color of the predetermined pixel to the stored colors before conversion if the predetermined pixel is input and a controller for transmitting the color of the predetermined pixel to the color cache when the predetermined pixel is input, controlling the color cache to search whether the same color as that of the predetermined pixel is stored in the color cache, acquiring a color after conversion from the color converter or the color cache according to the search result, and transmitting the color after conversion.

### BRIEF DESCRIPTION OF THE DRAWINGS

The above features and advantages of the present invention will become more apparent from the following detailed description when taken in conjunction with the accompanying drawing in which:

FIG. 1 is a diagram for describing a method of performing color conversion using a Color Look-Up Table (CLUT) among existing color conversion methods;

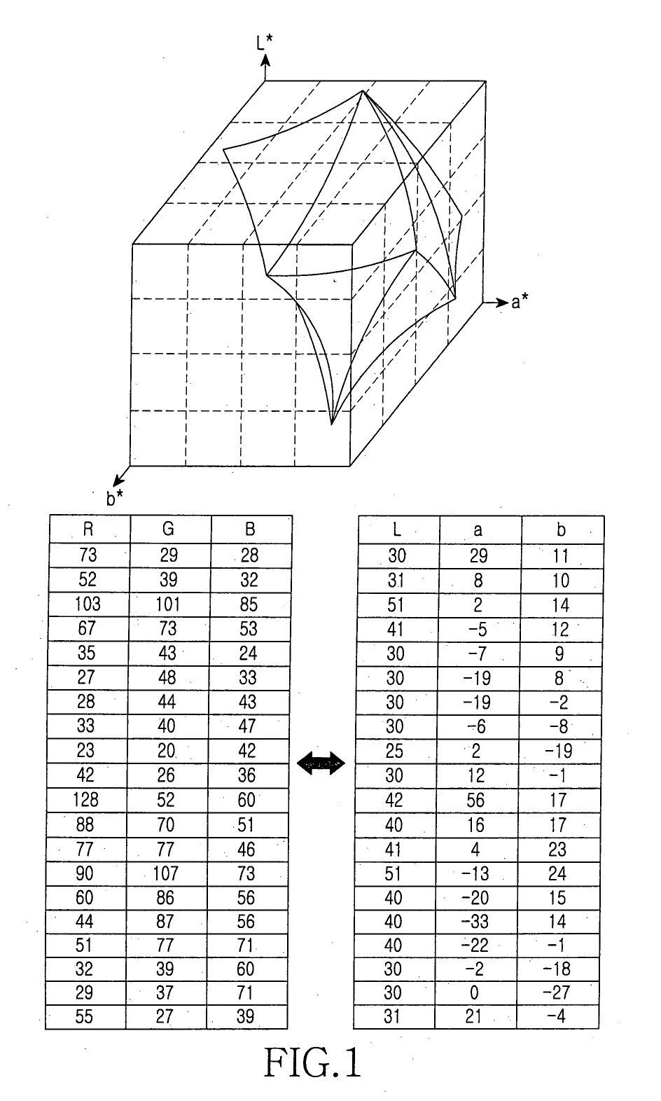

FIG. 2 is a block diagram of an apparatus for performing color conversion according to an exemplary embodiment of the present invention;

FIG. 3 is a configuration of a cache memory of a color cache according to an exemplary embodiment of the present invention;

FIG. 4 is a block diagram for describing a color search process of a color cache according to an exemplary embodiment of the present invention;

FIG. 5 is a flowchart illustrating a method of performing color conversion using a color cache according to an exemplary embodiment of the present invention;

FIG. 6 is a flowchart illustrating a color search process of a color cache according to an exemplary embodiment of the present invention;

FIG. 7 is a flowchart illustrating a color search process of a color cache according to another exemplary embodiment of the present invention; and

FIG. 8 is a flowchart illustrating a process of updating a record of a cache memory according to an exemplary embodiment of the present invention.

### DETAILED DESCRIPTION OF THE INVENTION

Embodiments of the present invention will be described herein below with reference to the accompanying drawings. For the purpose of clarity and simplicity, well-known functions or constructions are not described in detail so as not to obscure the invention.

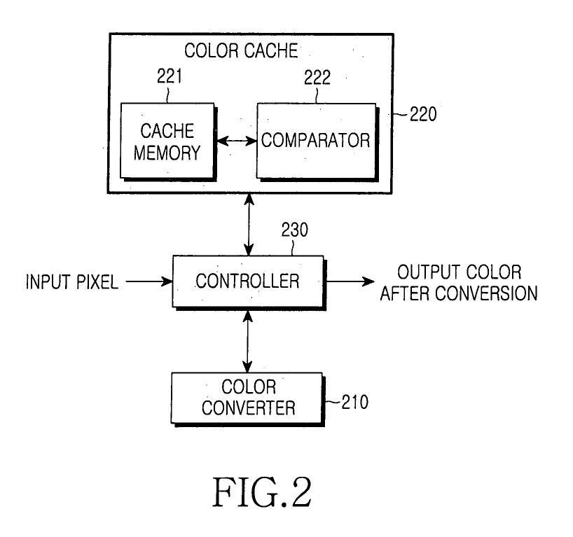

FIG. 2 is a block diagram of an apparatus for performing color conversion according to an exemplary embodiment of the present invention.

Referring to FIG. 2, the color conversion apparatus includes a color converter 210, a color cache 220, and a controller 230. The color converter 210 converts a color of an input pixel by performing color conversion using well-known color conversion methods, which need not be described in detail herein.

When a predetermined pixel for color conversion is input, the color converter 210 performs a color conversion operation on the predetermined pixel. Here, the color converter 210 performs the color conversion operation using at least one of the 4 existing color conversion described methods:

The first color conversion method is a method of performing color conversion using algorithm formulas directly implemented by a display device manufacturer or a user.

The second color conversion method is a method of performing color conversion by sampling only some colors in an entire color space, generating a conversion Color Look-Up Table (CLUT) of the sampled colors, and using various interpolation methods, e.g., tetrahedral interpolation, trilinear interpolation, and the like, for the remaining colors.

The third color conversion method is a method of performing color conversion using a polynomial regression-based interpolation equation.

The fourth color conversion method is a method of performing color conversion using a color mapping table of an entire color space.

Thereafter, the color converter 210 transmits the color after conversion to the controller 230.

The color cache 220 includes a cache memory 221 and a comparator 222. The cache memory 221 stores colors before conversion and colors after conversion of pixels color-converted by the color converter 210.

In the current embodiment, the cache memory 221 is constituted of at least one record, each record storing a color before conversion (high bits) and a color after conversion (low bits). If the cache memory 221 is constituted of two or more records, a separate update index is required to update a color before conversion and a color after conversion stored in each record.

When the color of the predetermined pixel is input from the controller 230, the color cache 220 searches for the same color as the color of the predetermined pixel by comparing the color of the predetermined pixel to the before conversion colors stored in the cache memory 221.

The process of searching for the same color as the color of the predetermined pixel by comparing the color of the predetermined pixel to the before conversion colors stored in the cache memory 221 is performed by the comparator 222., In one aspect, a single comparator 222 may be used. In other aspects, a plurality of comparators 222 may be used. For example, the number of comparators 222 may be equal to the number of records. The number of comparators 222 may be set, according to settings of a manufacturer or a user of the color conversion apparatus.

In a case where the number of comparators 222, which correspond to the number of records of the cache memory 221 (referred to herein as “n”), exist, when the color of the predetermined pixel is input, the color cache 220 transmits the color of the predetermined pixel to the n comparators 222 and respectively transmits the colors before conversion stored in the cache memory 221 to the n comparators 222, each comparator 222 being disposed for each record.

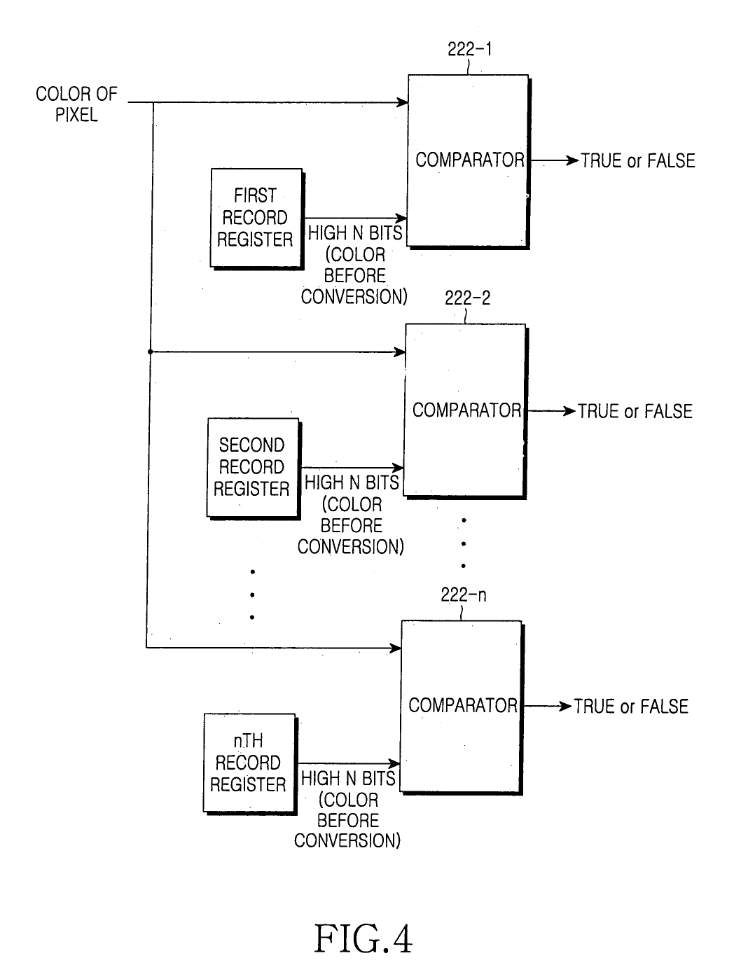

In this case, the n comparators 222 can perform the color search process at a high speed by comparing the color of the predetermined pixel to the colors before conversion in respective records at the same time. However, if the color cache 220 includes the n comparators 222, which correspond to the number of records of the cache memory 221, although the color search process can be performed at a high speed, much memory capacity is required. The process of searching for the same color as the color of the predetermined pixel by comparing the color of the predetermined pixel to the colors before conversion stored in the cache memory 221 with the n comparators 222 in the color cache 220 will be described in more detail with reference to FIG. 4.

In a case where a single comparator 222 is included in the color cache 220, when the color of the predetermined pixel is input, the color cache 220 transmits the color of the predetermined pixel to the comparator 222 and sequentially transmits the before conversion colors stored in the n records to the comparator 222 beginning at a selected one of the records. For example, the first record or from the record found to match a prior pixel inputted.

In this case, the comparator 222 can perform the color search process by sequentially receiving a before conversion color stored in each of the n records and comparing it to the color of the predetermined pixel. When the color cache 220 includes only one comparator 222, although much memory capacity is not required, the color search process takes long.

The number of comparators 222 included in the color cache 220 can be determined according to settings of the manufacturer or the user of the color conversion apparatus or a characteristic of the color conversion apparatus and is not limited to the two embodiments described (i.e., single or n comparators 222). For example, if the memory capacity of the color conversion apparatus is large, even if the n comparators 222 are included in the color cache 220, this will not affect the color conversion of the color conversion apparatus.

If the same before conversion color as the color of the predetermined pixel is found by the comparator 222, the color cache 220 acquires an after conversion color corresponding to the before conversion color found by the comparator 222 and transmits the acquired color before conversion to the controller 230.

If the same before conversion color as the color of the predetermined pixel is not found by the comparator 222, the color cache 220 informs the controller 230 that the same color as the color of the predetermined pixel is not stored in the cache memory 221.

The color cache 220 of the current embodiment can be implemented in a software form, wherein the CLUT is stored in a memory or a cache. In another embodiment, the CLUT may be included in a register of a Central Processing Unit (CPU) of a device for displaying an image. In the case of the register of the CPU, since a separate load command or separate address calculation is unnecessary, a color conversion speed can be can be increased over that of a CPU cache or an external memory.

When the predetermined pixel for color conversion is input, the controller 230 transmits the color of the predetermined pixel to the color cache 220 and controls the color cache 220 to search whether the same color as the color of the predetermined pixel is stored. When the same color as the color of the predetermined pixel is found in the color cache 220, an after conversion color corresponding to the predetermined pixel is determined and, the controller 230 outputs the after conversion color to the outside.

If the same color as the color of the predetermined pixel is not found in the color cache 220, the controller 230 transmits the color of the predetermined pixel to the color converter 210 to perform the color conversion operation. When a after conversion color obtained by performing the color conversion operation with respect to the color of the predetermined pixel is input from the color converter 210, the controller 230 transmits the after conversion color and the before conversion color to the color cache 220, controls the color cache 220 to update the cache memory 221, and outputs the after conversion color to the outside.

As described above, by the color conversion apparatus according to the current embodiment by comparing a color of a predetermined pixel input for color conversion to stored before conversion colors the color conversion operation and memory access required for the color conversion can be reduced when a matching color is found. This results in a decrease of power consumption and an increase of the color conversion speed.

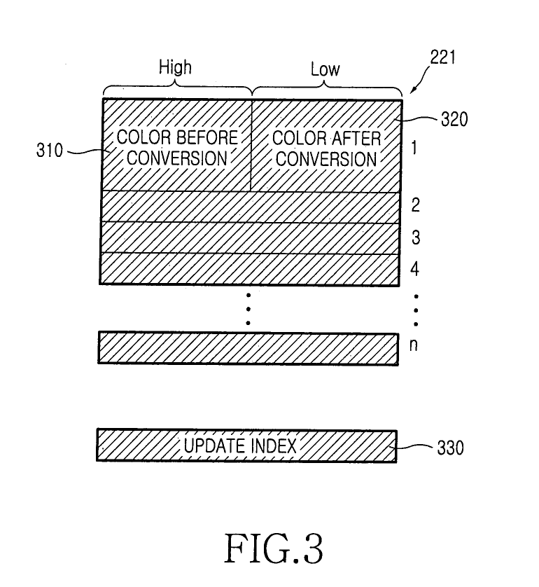

FIG. 3 is a configuration of a cache memory of a color cache according to an exemplary embodiment of the present invention.

FIG. 3 illustrates a case where first to n^{th} records constitute the cache memory 221 that store before conversion colors and after conversion colors.

As illustrated in FIG. 3, the cache memory 221 of the color cache 220 according to the current embodiment is constituted of “n” records for storing before and after conversion colors, wherein each record is divided into high bits 310 for storing a color before conversion and low bits 320 for storing a color after conversion.

In addition, the color cache 220 needs a separate update index 330 for updating a before conversion color and an after conversion color stored in each record.

When a color before conversion and a color after conversion of a predetermined pixel is input from the controller 230, the color cache 220 respectively stores the color before conversion (N bits) and the color after conversion (N bits) in the high bits 310 and the low bits 320 of a record of the cache memory 221, respectively. Thus, the size of each record is 2N bits.

That is, in the case where the cache memory 221 is constituted of at least one, i.e., n, records, when the n records in which the colors before conversion and the colors after conversion are stored are updated, the separate update index 330 is required, and if a color before conversion and a color after conversion of a new pixel is input, the color cache 220 updates the n records using the update index 330.

In the special case, when the cache memory 221 is a single record, the color cache 220 deletes the before conversion color and the after conversion color of a previous pixel, which are stored in the cache memory 221, and updates the record by replacing them with the color before conversion and the color after conversion of a new pixel.

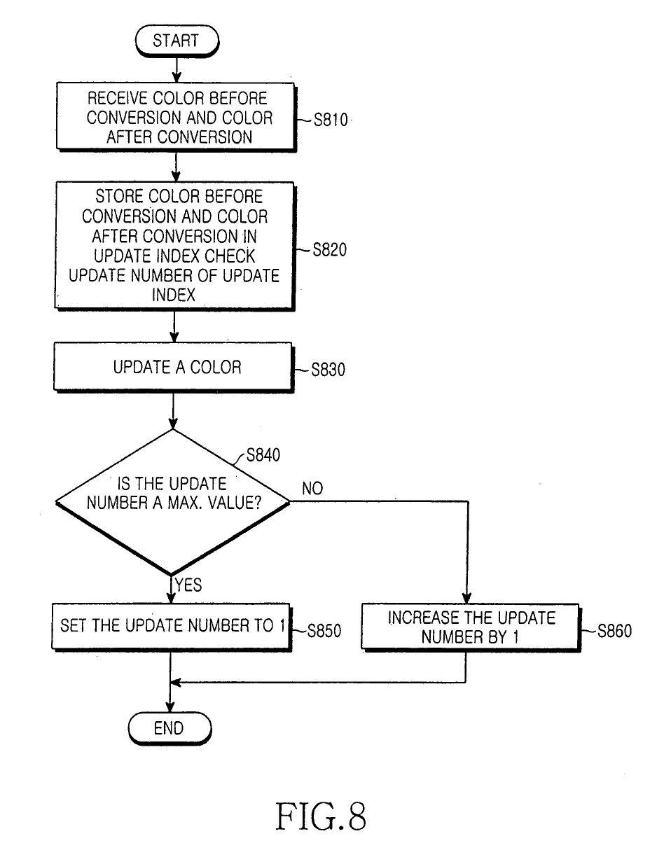

The process of updating a record of the cache memory 221 will be described in more detail with reference to FIG. 8.

FIG. 4 is a block diagram for describing a color search process of a color cache according to an exemplary embodiment of the present invention.

FIG. 4 illustrates a case where the number of records of the cache memory 221 for storing colors before conversion and colors after conversion is n and the number of comparators 222 is also n.

The color search process of the color cache 220 according to the one embodiment will now be described with reference to FIG. 4. When a color of a predetermined pixel is input from the controller 230 to search for the same color, the color cache 220 transmits the color of the predetermined pixel to each of comparators 222-1, 222-2, through to 222-n corresponding to the number of records of the cache memory 221.

Each of the comparators 222-1, 222-2, through to 222-n receives a color before conversion from a corresponding one of the n records and compares the color of the predetermined pixel to the color before conversion. Each of the comparators 222-1, 222-2, through to 222-n outputs ‘true’ if the same color is found or ‘false if the same color is not found.

The color cache 220 receives the comparison results of the comparators 222-1, 222-2, through to 222-n, acquires a color after conversion from a record of a color before conversion whose comparison result is ‘true’, and transmits the acquired color after conversion to the controller 230. If all the comparators 222-1, 222-2, through to 222-n output ‘false’, the color cache 220 informs the controller 230 that the same color as the color of the predetermined pixel is not found.

As described above, by preparing the comparators 222-1, 222-2, through to 222-n for the first to n^{th} records of the cache memory 221 for storing colors before conversion and colors after conversion, the color search process of an input predetermined pixel can be performed at a high speed.

In a case where the number of comparators 222 of the color cache 220 is one (1) according to settings of the manufacturer or the user of the color conversion apparatus, the color cache 220 sequentially transmits the colors before conversion stored in the n records to the comparator 222 from the first record, for example, to the comparator 222 to search for the same color as the color of the predetermined pixel. Even with the only one comparator 222 in the color cache 220, a comparison result is output as ‘true’ or ‘false’. The comparator 222 repeatedly performs the color search process for each of the number of records, and if the same color as the color of the predetermined pixel is found, the color cache 220 acquires a color after conversion from a record of a color before conversion whose comparison result is ‘true’ and transmits the acquired color after conversion to the controller 230.

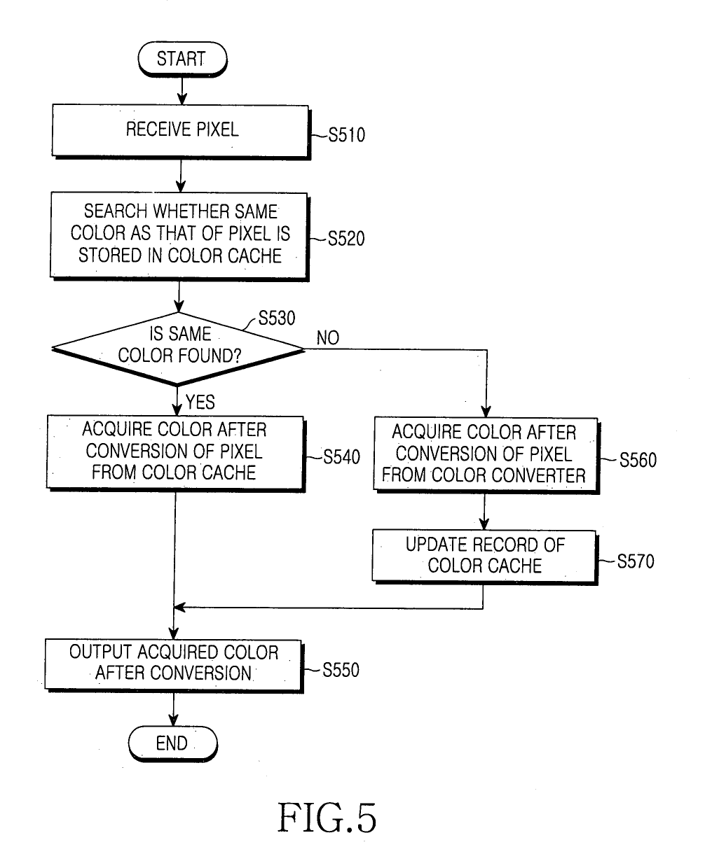

FIG. 5 is a flowchart illustrating a method of performing color conversion using a color cache according to an exemplary embodiment of the present invention.

Referring to FIG. 5, if a predetermined pixel is input to the controller 230 in step S510, in step S520, the controller 230 transmits a color of the predetermined pixel to the color cache 220 and controls the color cache 220 to search whether the same color as the color of the predetermined pixel is stored in the color cache 220.

The process of searching whether the same color as the color of the predetermined pixel is stored in the color cache 220 is performed by the comparator 222 of the color cache 220 as illustrated in FIG. 4, and the comparator 222 performs the color search process by comparing the color of the predetermined pixel to a color before conversion input from a record of the cache memory 221.

The number of comparators 222 may be one through n, where n corresponds to the number of records of the cache memory 221 according to settings of the manufacturer or the user of the color conversion apparatus or the characteristic of the color conversion apparatus.

When the number of comparators 222 is n, when the color of the predetermined pixel is input from the controller 230, the color cache 220 transmits the color of the predetermined pixel to each of the n comparators 222 and respectively transmits the before conversion colors stored in the cache memory 221 to corresponding n comparators 222, each comparator 222 being disposed for each record. The n comparators 222 perform the color search process by comparing the color of the predetermined pixel to the colors before conversion in respective records at the same time.

When the number of comparators 222 is 1, when the color of the predetermined pixel is input from the controller 230, the color cache 220 transmits the color of the predetermined pixel to the comparator 222 and sequentially transmits the before conversion colors stored in the n records to the comparator 222 from the first record, for example. The comparator 222 performs the color search process by sequentially receiving a before conversion color stored in each of the n records and comparing the color of the predetermined pixel.

If the same color before conversion as the color of the predetermined pixel is found by the comparator 222 in step S530, the color cache 220 acquires a corresponding after conversion color from a record of the found before conversion color and transmits the acquired after conversion color to the controller 230.

If the controller 230 acquires the after conversion color of the color of the predetermined pixel from the color cache 220 in step S540, the controller 230 outputs the acquired after conversion color in step S550.

If the same color before conversion as the color of the predetermined pixel is not found by the comparator 222 in step S530, the color cache 220 informs the controller 230 that the same color as the color of the predetermined pixel is not found in the cache memory 221.

If the same color before conversion as the color of the predetermined pixel input to the color cache 220 is not found, the controller 230 transmits the color of the predetermined pixel to the color converter 210 which controls the color converter 210 to perform a color conversion operation.

If the color of the predetermined pixel is input from the controller 230, the color converter 210 determines an after conversion color by performing the color conversion operation in step S560 and transmits the acquired after conversion color to the controller 230.

The color conversion operation performed for the color of the predetermined pixel by the color converter 210 can use at least one of the methods of performing color conversion as previously described: (1) algorithm formulas directly implemented by a display device manufacturer or a user, (2) sampling only some colors in an entire color space, generating a conversion CLUT of the sampled colors, and using various interpolation methods, e.g., tetrahedral interpolation, tri-linear interpolation, and the like, for the remaining colors, (3) polynomial regression-based interpolation equation, and (4) color mapping table of an entire color space. In the current embodiment, the color converter 210 acquires a color after conversion by performing the color conversion operation of the color of the predetermined pixel using at least one of the 4 color conversion methods. Although four color conversion methods are described herein, it would be recognized by those skilled in the art that other, non-describe, color conversion methods or techniques may be implemented and such methods are considered to be within the scope of the invention described herein.

When the controller 230 acquires the after conversion color from the color converter 210, the controller 230 transmits the after conversion color and the before conversion color to the color cache 220 and controls the color cache 220 to update a before conversion color and a after conversion color stored in the record of the color cache 220. If the color before conversion and the color after conversion are input from the controller 230, the color cache 220 updates the corresponding records associated with to the input before conversion color and after conversion color in step S570.

If the cache memory 221 is constituted of more than 2, i.e., n, records, when the records in which the colors before after conversion are stored are updated, a separate update index 330 is required, and when a color before and after conversion of a new pixel is input, the color cache 220 updates associated records using the update index 330.

However, if the cache memory 221 is only a single record, the color cache 220 deletes the stored before and after conversion colors of a previous pixel and updates the record by replacing them with a color before conversion and a color after conversion of the predetermined pixel.

After updating the record of the color cache 220, the controller 230 outputs the color after conversion of the predetermined pixel in step S550.

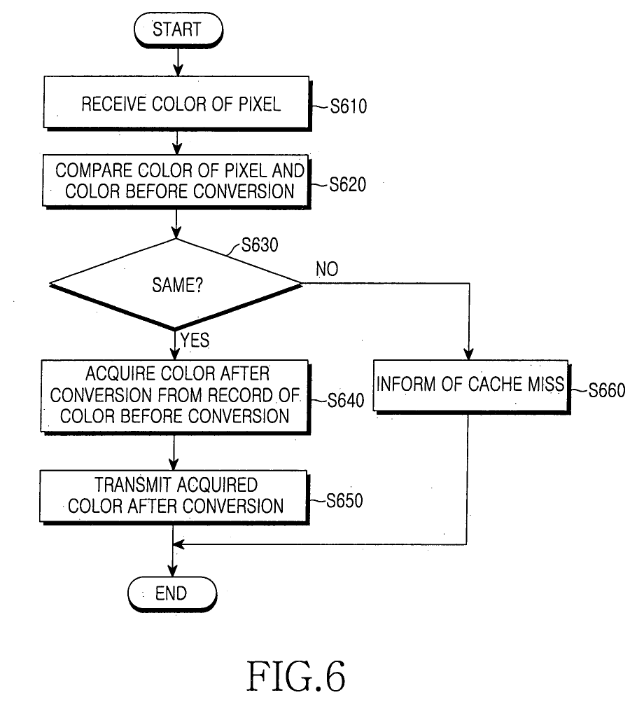

FIG. 6 is a flowchart illustrating a color search process of the color cache according to an exemplary embodiment of the present invention.

FIG. 6 illustrates a case where the number of records of the cache memory 221 for storing colors before conversion and colors after conversion is 1 and the number of comparators 222 for performing the color search process is 1.

In this case, since the number of records for storing a color before conversion and a color after conversion of a previous pixel is 1, the comparator 222 performs the comparison process of the color search process for a color of a predetermined pixel only once.

In addition, since the cache memory 221 can store a color before conversion and a color after conversion of only one pixel, if a comparison result of the comparator 222 is ‘false’, a color before conversion and a color after conversion of a previous pixel are deleted, the after conversion color of the predetermined pixel is acquired by performing the color conversion operation, and the record is updated to the acquired after conversion color and the before conversion color.

The color search process in this case, will now be described. If a color of a predetermined pixel for the color search process is input from the controller 230 to the color cache 220 in step S610, the color cache 220 transmits the color of the predetermined pixel and the before conversion color stored in the cache memory 221 to comparator 222.

The comparator 222 compares the color of the predetermined pixel and the color before conversion in step S620. If the color of the predetermined pixel is the same as the color before conversion in step S630 as the comparison result of the comparator 222, the color cache 220 acquires the associated after conversion color from the record in step S640. The color cache 220 transmits the acquired after conversion color to the controller 230 in step S650.

However, if the color of the predetermined pixel is different from the before conversion color in step S630 (i.e., comparator 222 output is False), the color cache 220 informs the controller 230 of the mismatch between the color of the predetermined pixel and the color before conversion in step S660.

Accordingly, in this case where the number of records of the cache memory 221 for storing colors before conversion and colors after conversion is 1 and the number of comparators 222 for performing the color search process is 1 the memory capacity of the color conversion apparatus is small.

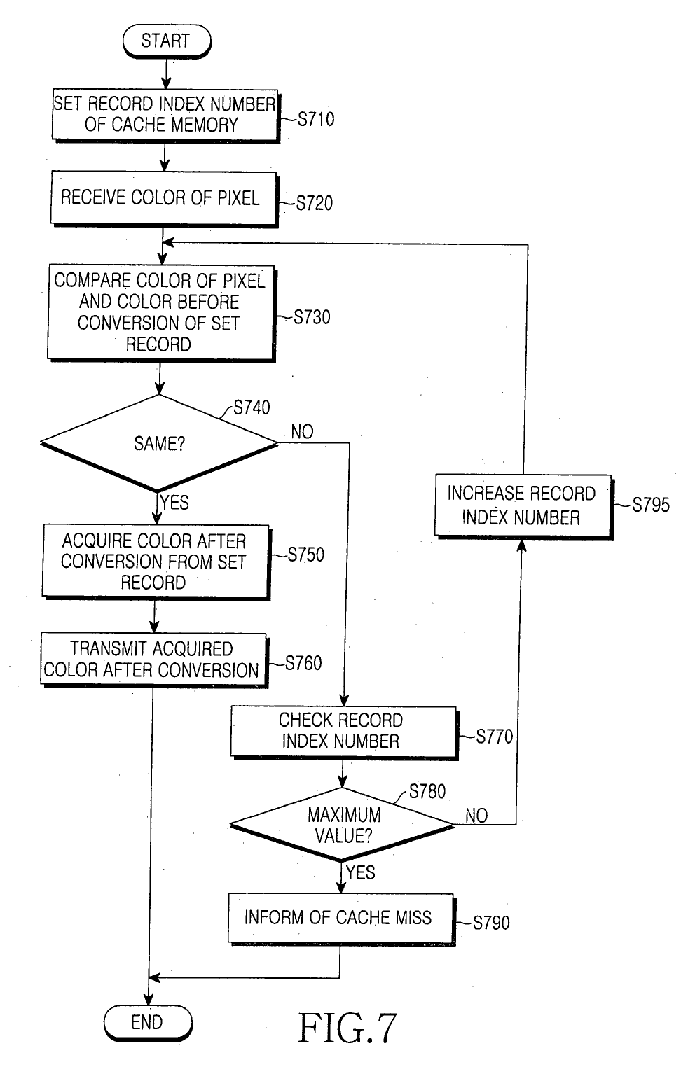

FIG. 7 is a flowchart illustrating a color search process of a color cache according to another exemplary embodiment of the present invention.

FIG. 7 illustrates a case where the number of records of the cache memory 221 for storing colors before conversion and colors after conversion is number greater than 1, i.e., n, and the number of comparators 222 for performing the color search process is 1.

In the case where the cache memory 221 is constituted of n records, since the number of records for storing colors before conversion and colors after conversion of previous pixels is n, the comparator 222 performs the comparison process of the color search process for a color of a predetermined pixel sequentially, n times.

The color search process in this case where the number of records of the cache memory 221 for storing colors before after conversion is n and the number of comparators 222 for performing the color search process is 1 will now be described. When a color of a predetermined pixel for the color search process is input from the controller 230 to the color cache 220, the color cache 220 sets a record index number of the cache memory 221, which is to be transmitted to the comparator 222, in step S710.

When the record index number of the cache memory 221 is set to 1 and the color of the predetermined pixel for the color search process is input from the controller 230 to the color cache 220, the color cache 220 transmits a color before conversion stored in the first record to the comparator 222.

The comparator 222 compares the color of the predetermined pixel and the before conversion color stored in the first record and the predetermined. When it is determined there is a difference from the color before conversion of the first record, the color cache 220 increases the record index number by 1 to sequentially transmit colors before conversion stored in the n records to the comparator 222.

If the record index number of the color cache 220 is set to 1 and the color of the predetermined pixel for the color search process is input from the controller 230 to the color cache 220 in step S720, the color cache 220 transmits the color of the predetermined pixel and the before conversion color stored in the first record of the cache memory 221 to the comparator 222.

The comparator 222 compares the color of the predetermined pixel and the before conversion color stored in the first record of the cache memory 221 in step S730. If the color of the predetermined pixel is the same as the before conversion color stored in the first record of the cache memory 221 as the comparison result in step S740, the color cache 220 acquires the corresponding after conversion color from the first record in step S750. The color cache 220 transmits the acquired color after conversion to the controller 230 in step S760.

However, if the color of the predetermined pixel is different from the color before conversion stored in the first record of the cache memory 221 as the comparison result in step S740, the color cache 220 determines in step S770 whether the record index number is n, i.e., the maximum value.

If it is determined in step S780 that the record index number is n, i.e., the maximum value, the color cache 220 informs the controller 230 of a cache mismatch between the color of the predetermined pixel and the colors before conversion stored in the cache memory 221 in step S790.

If it is determined in step S780 that the record index number is not n, i.e., the maximum value, the color cache 220 increases the record index number by 1 in step S795 to transmit the before conversion color stored in a subsequent record to the comparator 222.

If the color before conversion stored in the subsequent record is input, the comparator 222 performs the color search process again by performing the comparison process described above. The color search process of the comparator 222 is repeatedly performed until the record index number is n, i.e., the maximum value.

Although it has been described that the search process begins at the first record, it would be recognized that the process may be initiated at the last match found and that the search process continues for “n” records.

FIG. 8 is a flowchart illustrating a process of updating a record of a cache memory according to an exemplary embodiment of the present invention.

FIG. 8 illustrates the case where the number of records of the cache memory 221 for storing colors before and after conversion is n and the number of comparators 222 for performing the color search process is 1, which is illustrated in FIG. 7.

If a color before conversion and a after conversion color of a new (predetermined) pixel is input from the controller 230 to the color cache 220 in step S810, the color cache 220 stores the before conversion color and the after conversion color of the new pixel in the update index 330 in step S820. The color cache 220 acquires an update number of the update index 330 and stores the color before conversion and the color after conversion stored in the update index 330 in a record corresponding to the acquired update number in step S830. The update number indicates a record position used to store the color before conversion and the color after conversion of the new pixel in a record of the cache memory 221.

If the acquired update number of the update index 330 is n, i.e., the maximum value, in step s840, the color cache 220 sets the update number to 1 in step S850.

If the acquired update number of the update index 330 is not n, i.e., the maximum value, in step s840, the color cache 220 increases the update number by 1 in step S860.

By increasing the update number of the update index 330, the colors before conversion and the colors after conversion stored in the n records of the cache memory 221 can be updated in their stored order.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Since it will be understood by those skilled in the art that various changes in form and details may be made therein without departing from the spirit and scope of the invention, the embodiments described above and accompanying drawings are not limited thereto.

As described above, according to the present invention, by storing previously converted color information and comparing the color information and a color of a predetermined pixel using a color cache in a color conversion apparatus of an image processing system, an unnecessary color conversion operation and memory access can be reduced, resulting in a decrease of power consumption and an increase of a color conversion speed.

While the invention has been shown and described with reference to a certain embodiments thereof, it will be understood by those skilled in the art that various changes in form and details may be made therein without departing from the spirit and scope of the invention as defined by the appended claims.

What is claimed is:

1. An apparatus for performing color conversion using a color cache, the apparatus comprising:
a color converter for acquiring a color after conversion by performing a color conversion operation of a color of a predetermined pixel for color conversion;
a color cache for storing colors before conversion and colors after conversion of previous pixels color-converted by the color converter and searching for the same color by comparing the color of the predetermined pixel to the stored colors before conversion; and
a controller for transmitting the color of the predetermined pixel to the color cache, controlling the color cache to search whether the same color as the color of the predetermined pixel is stored in the color cache, acquiring a color after conversion from the color converter or the color cache according to the search result, and transmitting the color after conversion to the outside.

2. The apparatus of claim 1, wherein the color cache comprises:
a cache memory for storing colors before conversion and colors after conversion of previous pixels;
a comparator for comparing the color of the predetermined pixel and each of the colors before conversion stored in the cache memory; and
an update index for updating a record of the cache memory.

3. The apparatus of claim 2, wherein the cache memory is constituted of at least one record for storing the colors before conversion and the colors after conversion of the previous pixels.

4. The apparatus of claim 3, wherein each record is divided into high bits for storing a color before conversion of each previous pixel and low bits for storing a color after conversion of the previous pixel.

5. The apparatus of claim 2, wherein the number of comparators is selected from the group consisting of: 1 and n, wherein n corresponding to the number of records of the cache memory.

6. The apparatus of claim 1, wherein the color converter acquires the color after conversion by performing a color conversion operation of the color of the predetermined pixel using at least one of a method selected from the group consisting of: algorithm formulas, sampling only some colors in an entire color space, generating a conversion Color Look-Up Table (CLUT) of the sampled colors, and using various interpolation methods for the remaining colors, a polynomial regression-based interpolation equation, and a color mapping table of an entire color space.

7. The apparatus of claim 6, wherein the interpolation methods are selected from the group consisting of: a tetrahedral interpolation method, and a tri-linear interpolation method.

8. A method of performing color conversion using a color cache, the method comprising:
receiving a predetermined pixel for color conversion;
searching whether the same color as the color of the predetermined pixel is stored in a color cache;
acquiring a color after conversion of the same color found in the color cache; and
outputting the color after conversion.

9. The method of claim 8, further comprising the step of:
performing a color conversion operation by transmitting the color of the predetermined pixel to the color converter when not match is found in color cache, and determining an after conversion color of the color of the predetermined pixel.

10. The method of claim 9, wherein the step of determining the after conversion color comprises the step of:
performing the color conversion using at least one of a method selected from the group consisting of: algorithm formulas directly, sampling only some colors in an entire color space, generating a conversion Color Look-Up Table (CLUT) of the sampled colors, and using various interpolation methods for the remaining colors, a polynomial regression-based interpolation equation, and a color mapping table of an entire color space.

11. The method of claim 9, further comprising the step of:
transmitting the after conversion color and the before conversion color of the predetermined pixel to the color cache; and
updating a record of a cache memory for storing colors before conversion and colors after conversion of previous pixels.

12. The method of claim 11, wherein the step of updating of the record of the cache memory comprises the steps of:
receiving the color before conversion and the color after conversion of the predetermined pixel;
storing the color before conversion and the color after conversion of the predetermined pixel in an update index and acquiring an update number; and
updating a record corresponding to the acquired update number with the color before conversion and the color after conversion stored in the update index.

13. The method of claim 12, wherein the update number indicates a position of the record updated with the color before conversion and the color after conversion stored in the update index.

14. The method of claim 12, further comprising the step of:
if the acquired update number is the maximum value, setting the update number to 1, a color before conversion and a color after conversion stored in the first record of the cache memory to the color before conversion and the color after conversion stored in the update index, and increasing the update number

15. The method of claim 8, wherein the step of determing of whether the same color as the color of the predetermined pixel is stored in the color cache comprises the step of:
comparing the color of the predetermined pixel and a color before conversion stored in the color cache.

16. The apparatus as recited in claim 5, wherein the number of records is selected as n and the number of comparators is selected as one (1) and the records are sequentially applied to the records.

17. The apparatus as recited in claim 5, wherein the number of records and the number of comparators is selected as n and each of the n records is provided to a corresponding one of the comparators.

18. A computer-program product providing computer code, which when loaded into a computer system causes the computer system to execute the steps of:
receiving a predetermined pixel for color conversion;
searching whether the same color as the color of the predetermined pixel is stored in a color cache;
acquiring a color after conversion of the same color found in the color cache; and
outputting the color after conversion.

19. The computer-program of claim 18, further providing instruction to the computer system to cause the computer system to execute the steps of:
performing a color conversion operation by transmitting the color of the predetermined pixel when not match is found in color cache, and
determining an after conversion color of the color of the predetermined pixel.

20. The computer-program of claim 19, wherein the step of determining the after conversion color comprises the step of:
performing the color conversion using at least one of a method selected from the group consisting of: algorithm formulas directly, sampling only some colors in an entire color space, generating a conversion Color Look-Up Table (CLUT) of the sampled colors, and using various interpolation methods for the remaining colors, a polynomial regression-based interpolation equation, and a color mapping table of an entire color space.

21. The computer-program of claim 19, further providing instruction to the computer system to cause the computer system to execute the steps of:
transmitting the after conversion color and the before conversion color of the predetermined pixel to the color cache; and
updating a record of a cache memory for storing colors before conversion and colors after conversion of previous pixels.

22. The computer-program product of claim 21, wherein the step of updating of the record of the cache memory comprises the steps of:
receiving the color before conversion and the color after conversion of the predetermined pixel;
storing the color before conversion and the color after conversion of the predetermined pixel in an update index and acquiring an update number; and
updating a record corresponding to the acquired update number with the color before conversion and the color after conversion stored in the update index.

23. The computer-program product of claim 22, wherein the update number indicates a position of the record updated with the color before conversion and the color after conversion stored in the update index.

24. The computer-program product of claim 22, further providing instruction to the computer system to cause the computer system to execute the steps of:
if the acquired update number is the maximum value, setting the update number to 1, a color before conversion and a color after conversion stored in the first record of the cache memory to the color before conversion and the color after conversion stored in the update index, and increasing the update number

25. The computer-program product of claim 22, wherein the step of determining of whether the same color as the color of the predetermined pixel is stored in the color cache comprises the step of:
comparing the color of the predetermined pixel and a color before conversion stored in the color cache.
